(19) United States
(12) Patent Application Publication
(10) Pub. No.: US 2001/0029527 A1
(43) Pub. Date: Oct. 11, 2001

(54) Method and system for providing a customized browser network

(76) Inventor: Nadav Goshen, Tel-Aviv (IL)

Correspondence Address: Eltan, Pearl, Latzer & Cohen-Zedek, One Crystal Park, Suite 210, 2011 Crystal Drive, Arlington, VA, 22202-3709, US

(21) Appl. No.: 09/808,125

(22) Filed: Mar. 15, 2001

Related U.S. Application Data
(60) Provisional application No. 60/189,493, filed on Mar. 15, 2000.

(51) Int. Cl. G06F 15/16

(52) U.S. Cl. 709/218; 709/219

(57) ABSTRACT

A method including identifying a Uniform Resource Locator (URL) associated with at least one content provider and a browser, and customizing the browser by modifying at least one portion of the browser based upon the URL.

### RELATED APPLICATIONS

This application claims the benefit of provisional application Ser. No. 60/189,493, filed on Mar. 15, 2001, which is incorporated in its entirety by reference herein.

### FIELD OF THE INVENTION

This invention relates generally to web browsers on the Internet and particularly to a method and system for providing a customized browser network.

### BACKGROUND OF THE INVENTION

It is well known to couple a plurality of computer systems into a network of computer systems. In this way, the collective resources available within the network may be shared among users, thus allowing each connected user to enjoy resources that would not be economically feasible to provide to each user individually. With the growth of the Internet, sharing of computer resources has been brought to a much wider audience. The Internet has become a cultural medium in today's society for both information and entertainment. Government agencies employ Internet sites for a variety of informational purposes. For many companies, one or more Internet sites are an integral part of their business; these sites are frequently mentioned in the companies' television, radio and print advertising.

The World Wide Web, or simply “the Web”, is the Internet's multimedia information retrieval system. It is the most commonly used method of transferring data in the Internet environment. Other methods exist such as the File Transfer Protocol (FTP) and Gopher, but have not achieved the popularity of the Web. End-user machines accomplish transactions to Web servers using the Hypertext Transfer Protocol (HTTP), which is a known application protocol providing users access to files, e.g., text, graphics, images, sound, video, using a standard page description language known as the Hypertext Markup Language (HTML). HTML provides basic document formatting and allows the developer to specify “links” to other servers and files. In the Internet, a network path to a server is identified by a Uniform Resource Locator (URL) having a specific syntax for defining a network connection.

Retrieval of information is generally achieved by the use of an HTML-compatible “browser”, such as the well-known Netscape Navigator, for example, at an end-user machine. When the user of the browser specifies a link via a URL, the end-user issues a request to a naming service to map a hostname in the URL to a particular network IP address at which the server is located. The naming service returns a list of one or more IP addresses that can respond to the request. Using one of the IP addresses, the browser establishes a connection to a server. If the server is available, it returns a document or other object formatted according to HTML. Web browsers have become the primary interface for access to many network and server services.

The entry of the URL in the entry field of a browser can be a difficult task for many users. While the URL for the main Web page of a major company can be relatively brief, subsidiary pages can have very lengthy URLs in, at least to the average user, an arcane syntax. Recognizing the difficulties involved, the developers of browsers have provided one useful means of returning to a favorite URL, by the creation of user stored “bookmarks” in the browser.

Web browsers offer many options in the user interface for creating a bookmark list. Basic options let the user add and access a page through a pop-up menu on the location toolbar or through a menu pulldown from the main menu bar. A simple way to add a bookmark for a favorite page is to enter the URL to travel to the page, once there, open the Bookmarks menu and choose the Add Bookmarks selection. This set of actions adds the URL of the current page as an item in the Bookmarks menu.

Once created, bookmarks offer a means of page retrieval. The user can cause the browser to display his bookmark list and select among his bookmarks to go directly to a favorite page. Thus, the user is not forced to enter a lengthy URL nor retrace the original tortuous route through the Internet by which he may have arrived at the Web site. Once a bookmark is added to a bookmark list, in general, the bookmark becomes a permanent part of the browser until removed. The permanence and accessibility of bookmarks have made them a valuable means for personalizing a user's Internet access through the browser.

Yet despite their usefulness, the current arrangement of bookmarks is not without its flaws. As the numbers of web sites and web pages on these sites have increased dramatically, so has the number of bookmarks that a typical web browser user maintains on his browser. It is not uncommon that hundreds of bookmarks be stored in a bookmark file after a few weeks of web browsing. While folders in some browsers have helped the user group his/her bookmarks by category, in reality, the bookmark file is one huge list of bookmarks, all accessible to the user through the browser.

Bookmarks are just one example of navigation functionalities used in browsers. In general, there is a problem of access control, and the same holds true for other navigation functionalities of prior art browsers. In general, there is a problem of access control, and the same holds true for other navigation functionalities of prior art browsers.

### SUMMARY OF THE INVENTION

The present invention seeks to provide a method and system for providing a customized browser network. The invention provides a new way of using the browser in order to retrieve information over the Internet. The invention provides tools and techniques to merge the browser and web page into one combined module. The invention changes the browser and extends its capabilities as a delivery platform for information. The invention seeks to use this customized browser to present and improve access to information that is related to the specific web site/web page being viewed. Thus, web site graphics, links, promotions and site maps that are conventionally displayed on the web site may be moved to the browser. This frees up space on the document display area for more content and provides one navigation system that is standardized across multiple web sites (eliminating the need for users to learn different navigation methods on different sites). The customized browser automatically changes and updates so as to provide the best browser configuration and settings with respect to the web site being viewed or to user preferences.

The invention combines a browser add-on with an advanced networked browser server to provide a dynamic and customized browser system.

Browsers consist of two major modules: the “document display area” the area within the browser which is used to present the HTML/HTTP content, and the “browser controls area” which are a set of functions and tools to control the browser (for example, file menu, back/forward buttons, status bar, etc). The browser control area may include a toolbar that adds browser functionality.

The invention may comprise a browser add-on application that preferably comprises network and management modules and a variety of “morphs”. Morphs are active components that change the browser's look and functionality according to the web site being viewed. Each morph is responsible for a component of the browser (graphic, text or other) that is dynamically modified and adapted to the web site being visited or to user preferences. An example of a morph may be a button an the browser called “help” that always provides a link to the help page of the web site presently being viewed. Thus, each morph may be responsible for a specific aspect of the browser look or functionality and may customize that aspect according to data from the browser server over the Internet. As a user visits different web sites, different morphs are activated by the browser add-on application (the “client module” also referred to as the “client”) to customize the user's browser using data from the browser server smart logic database system. Any number of “morphs” may be added to enhance the browser and surfing experience.

One type of morph includes graphics on the browser controls area. (These graphics may also be referred to as browser skins.) The graphical browser top may be used for marketing purposes including branding the web site or promotion of products/services on specific sites. For example, a user entering the Amazon.com web site may see a browser control area with graphics and colors that compliment the web site and with promotions for the newest or most popular products on the site, When the user then visits the “yahoo.com” web site, the user's browser is modified to show a browser control area with graphics and promotions related to “yahoo.com”.

Another type of morphs comprises a “dynamic navigation toolbar”. This system allows users to get to any page within the web site with just one mouse click. This morph includes hierarchical pull-down menus that provide links to the different pages within the web site. This morph makes navigating through the web pages of the web site simple and quick. Most web sites (e.g. Yahoo, Amazon, CNN) have a vertical component and require the user to move down “branches” in order to find the required information, often requiring the user to load intermediate pages that are of no value. The present invention eliminates the need to load intermediary web pages.

Additionally, by providing a consistent navigation platform across different web sites, the toolbar may be modified into a standardized tool for navigating web sites and may reduce the learning process required to understand the different architectures and layouts of different web sites. Furthermore, the navigation platform that is embedded into the browser eliminates the need for the content provider to use screen space for navigation and allows the content provider to focus on the content while the navigation is handled through the browser. (Throughout the specification and claims, “content provided” refers to any web site.)

Another morph is a site bookmark that allows users to save web pages they like on a per-web-site basis. The advantage of this method is that the web-site bookmarks only appear when the user re-visits the web site. This creates an intuitive bookmark classification application whereby users can store the pages on the site that they like best and have these bookmarks automatically loaded when they re-visit the site. This morph may consist of a button on the browser controls area which, when clicked on, presents the users bookmarks for that web site. As the user surfs from one site to the next, the content of this button is updated such that the button always contains the bookmarks for the site being viewed. The site bookmark morph may also include standard bookmark management features, such as rename, delete, etc. The user may choose to automatically copy entries from the site bookmarks to his/her conventional bookmark system, and regular bookmarks may be transferred/copied into the site bookmarks and arranged on a per-site basis.

Another morph includes dynamically changing function buttons, In other words, the method of the invention may dynamically change the browser function buttons (back, forwarded, stop, etc) into site-specific buttons. This embodiment may relate to the functionality or visual appearance of the buttons. For example when a user goes to the “Disney.com” web site, the standard browser function buttons (back, forwarded, stop, etc.) may change and include images related to Disney characters.

Another morph may include a rotating icon, wherein the morph may change the standard browser icon with images/movies related to the site logo/concept. A mouse icon morph may change the mouse icon according to the site logo/graphical concept. A hotkey morph may be provided which adds to or changes the regular keyboard shortcuts to a set of global keyboard shortcuts that have similar functionality on all sites. For example, pressing Alt+s on all sites may permit advancing to the site's sale page. Another morph may be a shaped morph that changes the browser shape according to the site (round or triangle, for example). For example, the browser may change its design to a new kind of window. Sites with this kind of functionality may have to set their pages accordingly.

The browser modification of the invention may also include links to common sections in web sites. These morphs may include a button on the browser with links to the web site home page, help section, site map, privacy policy, etc.

The client is a browser add-on application that may be downloaded either at the browser server site, from other site/s or embedded within the browser (as an OEM browser addition/extension, pre-install plug-in in or in any other way, eliminating the need for a download). The client program is simple to install and, after installation, automatically links to the users browser and to the browser server. From this point on, data is transferred from the client software to the browser server and vice versa. Based upon this data, the client software changes the browser's appearance and functionality, using the morph modules. The changes may be customized according to the site being viewed and/or according to user preferences. Both forms of customization are possible through data that is stored in the browser servers and delivered to the client module as the user surfs the web.

The browser server is preferably a server farm system that is based on a high traffic network architecture concept, using hardware and software load balancing architecture to support all or part of the client modules. The server system preferably serves clients based on a client-server mode. The server system preferably comprises a communication control module, a database and data management module, a web interface module and a registration server module. The browser server preferably controls storing, retrieving and managing database information using a smart logic data processing, as the browser server processes requests from clients over the Internet. The client may send the browser server a request that includes, among other things, a URL and a user identification (UID). The browser server processes the received URL and UID, and according to information stored in the databases, sends back one or more browser add-on data (also referred to as “morph data”) to the relevant client. This information may be sent in a property protocol (browser network protocol) format, Alternatively to this server farm, a remote browser server component may be installed as web server extensions on approved sites. As another alternative, special tags (HTML, XML or other) may be embedded within the web page in order to activate one or more morphs with custom data. This allows such approved sites to automatically link with the client and transfer data and morphs, thereby enabling the content provider to directly change the browser's look and functionality. Activation of this service may be controlled and approved by the browser server system. The above alternatives may provide some or all of the browser server features.

The browser server network protocol may be based on XML, and formats the morph and other data in a logical way. The protocol defines the manner in which to customize the browser and provides the information and data necessary to change each morph.

A number of methods for customizing the browser environment are provided in the present invention.

Web Page Customization: This is the highest level of browser customization offered. Under this level of customization, morphs allow the browser to change on a web page basis (based upon URL). Thus, the browser, including the browser controls area, is updated based on the page being viewed. An example of a web page customization is a different text message that appears on the browser controls area on different pages within the same web site.

Web Site Customization: This level of customization is on a per web site basis. Under this level of customtizaton, morphs allow the browser to change on a web site basis. Thus, the browser, including the browser controls area, is updated based on the site being viewed For example, while surfing the web and visiting the “yahoo.com” web site, the browser control area may display promotions related to “yahoo.com”. After leaving “yahoo,com” and going to the “AOL.com” web site, the browser control area may change and display promotion related to “AOL.com”.

Category Specific Customization: This is a lower level of customization and allows the browsers to be customized on a category basis. With this method, web sites that provide similar services or that are related to the same field would be customized identically. For example, both the “MarketWatch.com” and “TheStreet.com” web sites would be customized identically with information related to other financial web sites.

Another type of category specific customization may include modifying the browser in order to promote web sites, products or services based on a predefined category of web sites. For example, this could include promoting the Barnes and Nobles site or B&N product/s by an image such as a browser skin, link to B&N or buttons displayed on the browser, while the user is viewing other sites belonging to a book category.

User Customization: This customization is based on the user's needs and preferences. All users of the system are unique and have their preferences and user profiles listed on the browser server's database. This profile determines the browser configuration for each user, and the client module is fed the relevant data necessary for customizing the browser to the needs of each specific user.

Theme-based Customization: This customization provides browser configuration according to one or more themes, For example, a user can choose to receive a sport theme. While the user is surfing, the graphical browser top morph may be updated with sport related illustrations and information. Furthermore, the browser environment may be customized according to this theme. For example, the browser buttons may have sport images, the navigation toolbar may have sport sites, and the mouse icon may change with sport related images.

A theme may be activated or started by entering a web site, which may be at the browser server, and clicking on a desired graphic/text theme representation. This updates the client and/or the browser server with the new preferences, and notifies the browser server and the client to send/receive the relevant morph data to the client and user.

The methods of customizing the browser environment are controlled by the browser network servers, which provide a hierarchy mode of operation. For example, site customization mode may overrule theme-based customization. In such a hierarchy, when a user who chooses to receive a sport theme goes to a web site that is listed at the browser server as a customized site, the theme customization may be overruled and the browser may be customized to the web site.

The client module may retrieve a UID from the browser server using the registration server module. A UID may be assigned to the client module with default settings. Afterwards, the user may have the option to change the settings upon request. Changes may be registered and stored in the browser server. The UID assignment process may take place on a single/multiply user/s per-PC basis. In addition, the user may have the option to use the same UID for different PCs. To maximize such portability, customized data (bookmarks, security setting, and the like) may be transferred from the client module to the browser server, and may be sent back to the client module upon the next login from a different PC.

The client module preferably includes a connection manager, which is adapted to establish and deal with communications between the client module and the browser server, to decode/encode, encrypt/decrypt and compress/decompress the property protocol and morph data. The connection manager may also be adapted to synchronize morph data transfer with the browser activities so as to minimize waiting time. In order to optimize the transfer of morph data, the connection manager may use a smart combination of a preload system and file caching in order to exploit inactivity times to download morph data to the user machine. This optimization preferably does not interfere with the actual page download process. Other methods of optimizing data transfer may include using prior knowledge of popular web sites that the user is visiting, high traffic web sites, portals, or other methods. For example, morph data for other pages on the site may be downloaded as the user visits the home page of a web site.

The connection manager may able to receive protocol and morph data in a compressed format and decompress the data in order to minimize bandwidth use.

The client module preferably includes a cache module. The cache module may store morph data locally, thereby reducing the need to download morph data from the browser server. This way a user who revisits a web site receives the morphs from the cache module instead of from the browser server. The cache module may use a combination of push and pull cache mechanisms and work with the connection manager to preload data, as similarly described for the connection manager.

There is thus provide in accordance with a preferred embodiment of the present invention a method including identifying a Uniform Resource Locator (URL) associated with at least one content provider and a browser, and customizing the browser by modifying at least one portion of the browser based upon the URL.

In accordance with a preferred embodiment of the present invention the modifying includes updating the browser in accordance with at least one of a content provider criterion and a user preference criterion.

Further in accordance with a preferred embodiment of the present invention the at least one content provider belongs to a family of content providers that are categorized by at least one of a category and theme, and the method includes updating the browser in accordance with that category and/or theme.

Additionally in accordance with a preferred embodiment of the present invention the method includes sending a request for the URL and a user identifier (UID) to a browser server, which is in communication with the browser.

In accordance with a preferred embodiment of the present invention the browser server is provided with a database including at least one of user preference data and content provider data.

Further in accordance with a preferred embodiment of the present invention the modifying includes creating browser modification information based upon the at least one of user preference data and content provider data, and sending the browser modification information to the browser.

Still further in accordance with a preferred embodiment of the present invention the method includes receiving a web page from the content provider in accordance with the request for the URL, and displaying the web page together with the browser modification information by the browser.

In accordance with a preferred embodiment of the present invention the modifying includes branding the browser with a commercially related browser modification.

There is also provided in accordance with a preferred embodiment of the present invention apparatus including a browser server adapted to modify a browser with browser modification information created by the browser server.

In accordance with a preferred embodiment of the present invention browser modification information is created by the browser server, wherein the browser modification information is adapted to change at least one of an appearance and functionality of the browser.

Further in accordance with a preferred embodiment of the present invention a client module is provided which is in communication with the browser server and the browser, the client module being adapted to change at least one of an appearance and functionality of the browser with the browser modification information.

Still further in accordance with a preferred embodiment of the present invention the browser modification information may include, but is not limited to, a dynamic toolbar, a dynamic browser skin, a dynamic browser user interface, a dynamic navigation tool, a dynamic browser function button, a dynamic site bookmark, a dynamic rotating icon, a dynamic mouse icon, a dynamic hotkey, a dynamically shaped browser, and/or dynamic branded information.

In accordance with a preferred embodiment of the present invention the browser server is adapted to process a request for a URL and a UID, and update the browser in accordance with at least one of a content provider criterion and a user preference criterion based upon the URL and the UID, respectively,

### BRIEF DESCRIPTION OF THE DRAWINGS

The present invention will be understood and appreciated more fully from the following detailed description taken in conjunction with the appended drawings in which:

FIG. 1 is a simplified block diagram illustration of apparatus for modifying a user's browser with browser modification information, constructed and operative in accordance with a preferred embodiment of the present invention;

FIG. 2 is a simplified flow chart illustration of a method for modifying a user's browser with browser modification information, in accordance with a preferred embodiment of the present invention; and

FIGS. 3-6 are simplified illustrations of a browser provided with different types of browser modification information from a browser server in accordance with different preferred embodiments of the present invention, wherein

FIG. 3 is a simplified illustration of web page or web site customization,

FIG. 4 is a simplified illustration of category specific customization,

FIG. 5 is a simplified illustration of user customization, and

FIG. 6 is a simplified illustration of theme-based customization.

### DESCRIPTION OF THE PREFERRED EMBODIMENT

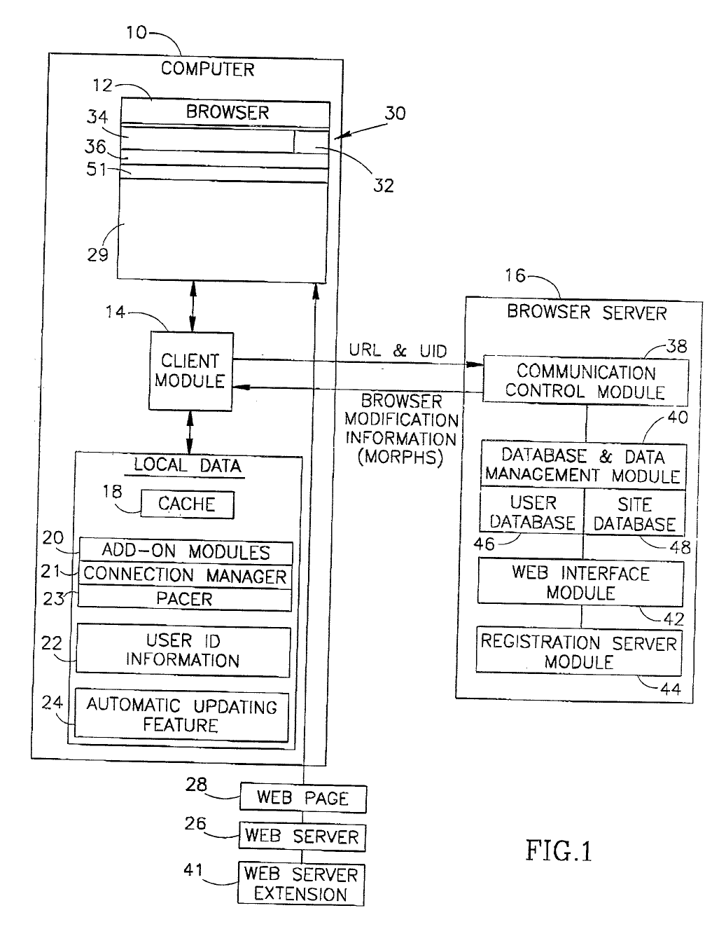

Reference is now made to FIG. 1, which illustrates apparatus for modifying a user's browser with browser modification information, in accordance with a preferred embodiment of the present invention.

A user's computer 10 may receive information by means of a browser 12, typically, although not limited to, an HTML-compatible “browser”, such as the NETSCAPE NAVIGATOR, for example. A client module 14 is provided, which comprises hardware and/or software for communication with browser 12 and with a browser server 16. Client module 14 and browser server 16 may be remote or local to computer 10.

Client module 14 is preferably a browser add-on application that may be downloaded either at the browser server site or from one or more other sites. Alternatively, client module 14 may be embedded within the browser as an OEM browser addition/extension or pre-install plug-in, for example, thereby eliminating any need for a download. Client module 14 is simple to install, and after installation, automatically links between the user's browser 12 and the browser server 16.

Client module 14 may be connected to browser 12 in any suitable manner. The URL, which is entered in the address bar or through a hyperlink at the browser 12, may be continuously relayed by client module 14 to browser server 16. The browser server 16 may return morph data accordingly, and using this data, the client module 14 may activate its “morph” modules and thus customize the look and functionality of browser 12.

Client module 14 may comprise local data features, such as a cache 18, one or more add-on modules 20, such as a connection manager 21 and a pacer 23, user identification information 22, and an automatic updating feature 24, all of which are described more in detail hereinbelow.

Browser 12 is preferably in communication with a web server 26, such as from any well-known content provider available through the Internet, which provides one or more web pages 28 for display on a document display area 29 by computer 10. Browser 12 preferably has a browser controls area, that comprises a browser top 30, which typically comprises a skin 32 (i.e., the background graphics of the browser top 30), a toolbar 34 (such as the familiar FILE, EDIT, VIEWS and TOOLS toolbar, for example) and function “buttons” or “keys” 36 (such as the familiar BACK, FORWARD and HOME function keys, for example).

Browser server 16 is preferably a server farm system that is based on a high traffic network architecture concept, using hardware and software load balancing architecture to support all of the clients of browser server 16. The server system preferably serves clients based on a client-server mode.

The server farm provides information needed by all of the clients and may be logically divided into four major modules; a communication control module 38, a database and data management module 40, a web interface module 42 and a registration server module 44.

The database and data management module 40 preferably comprises a user database 46, which may comprise, without limitation, user identifier information (UID), user preference data, and login information, for example. The database and data management module 40 preferably further comprises a site database 48, which may comprise, without limitation, website or URL data and morph data, such as customized browser top graphics, customized tootbars, etc.

The server farm is responsible for providing morph data as a user surfs the Internet. The browser server 16 preferably controls storing, retrieving and managing the database information using a smart data processing (smart logic). The browser server 16 processes a URL request and UID sent by a client, and delivers browser modification information (also referred to as “morph/s data”) based on the received URL and UID information and the information stored in the databases. Browser server 16 is capable of continuously customizing browser 12 with the browser modification information. The browser modification information may change the appearance and/or functionality of the browser 12 and/or the browser control area by the different morphs, such as by means of added graphics in a portion 51 of browser top 30.

The receipt, transfer and transmission of all data related to web sites or user preferences may be controlled over the Internet by the web interface module 42. It is noted that users and site administrators may insert desired preferences and characteristics into the system of the present invention.

The communication control module 38 may be responsible for supporting server browser clients as they interrogate for information over the Internet, The communication control module 38 may be implemented using hardware and software designed to face high traffic. The communication control module 38 may also be responsible for decoding/encoding protocol, and for any other communicating with remote clients.

Registration server module 44 may be responsible for assigning new UIDs to clients, and is adapted to track and respond to user migration from one computer to other and to deal with multiple users on one personal computer (PC).

Alternatively to the server farm, a remote browser server component may be installed as one or more web server extensions 41 on approved sites. As another alternative, special tags (HTML, XML or other) may be embedded within the web page in order to activate one or more morphs with custom data. These alternatives may consist of all or part of the browser server futures and capabilities as described above This allows such approved sites to automatically link with the client and transfer morph or other data, thereby enabling the content provider (also referred to as the “website”) to directly change the browser's look and functionality. Activation of this service may be controlled and approved by the browser server system.

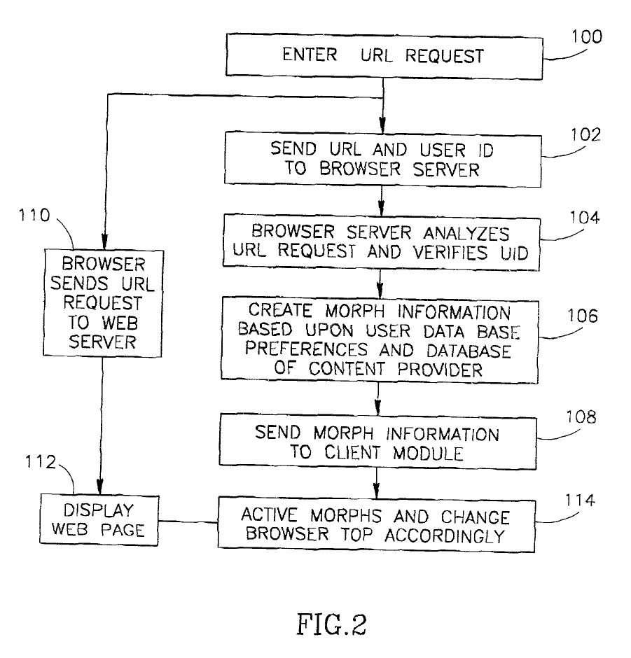

Reference is now made to FIG. 2, which is a flow chart of a method for modifying a user's, browser with browser modification information, in accordance with a preferred embodiment of the present invention. The description follows the above-described apparatus of FIG. 1.

A user enters a URL request (step 100). The client module 14 relays the URL request and the UID of the user to the browser server 16 (step 102). Browser server 16 analyzes the URL request and the UID (step 104). Browser server 16 creates morph data (i.e., browser modification information) based upon the user preferences and the content provider (i.e., website) data stored in the user database 46 and site database 48 of the database and data management module 40 (step 106). Browser server 16 then sends the morph data to the client (client module 14) in step 108.

In the meantime, in parallel to the steps performed by the browser server 16, the browser 12 sends the URL request in the conventional manner to web server 26 (step 110). Web server 26 sends the requested web page 28, which is displayed by computer 10 (step 112). In parallel with the display of the web page 28, the client module 14 activates the morphs and changes the appearance and/or functionality of the browser 12 and/or the browser control area accordingly.

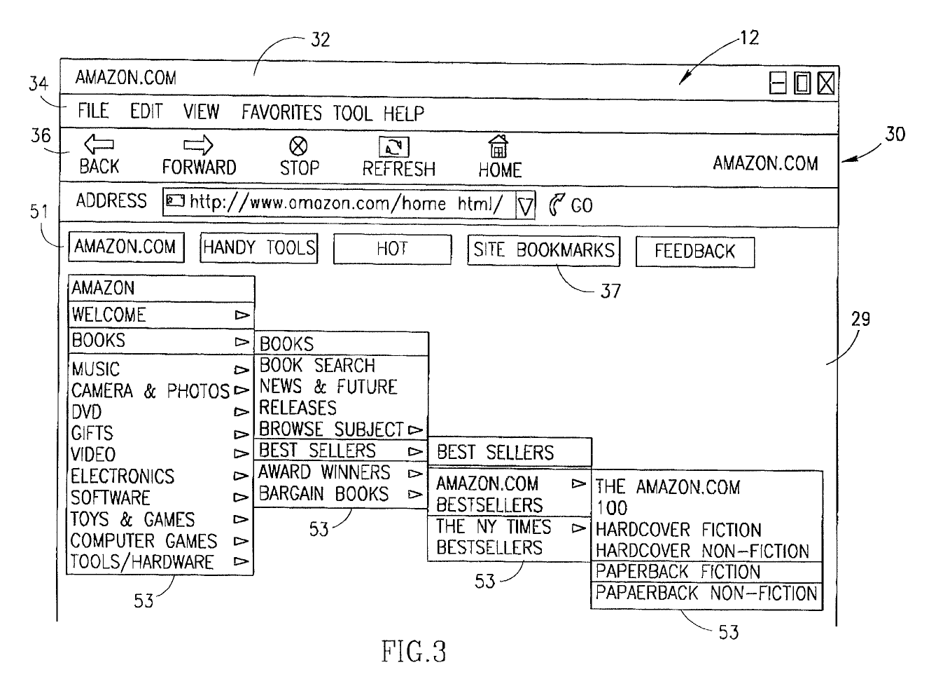

A number of methods for customizing the browser environment are provided in the present invention, examples of which are now described with reference to FIGS. 3-6,

One type of customization is web page or web site customization, which allows browser 12 to be tailored exactly to the web site being viewed or to sections within this site or to one specific web page. An example of web site customization is shown in FIG. 3, for the amazon.com web site. The browser top 30 may be modified to be graphically similar to the amazon.com web site, with an additional display or overlay of graphics and text promotions or any other information, for example. The browser top 30 may be enhanced with the “amazon.com” logo and/or graphic illustrations of products, which may be used as hyperlinks to the product sale page. The graphical browser top 30 may be used for other marketing purposes.

The browser modification may comprise a dynamic toolbar in portion 51 with pull-down menu/s 53, which reflects all or part of the site map and assists the user in navigation. This makes navigating through the web pages of the web site much simpler and quicker. This application makes intra-web-site navigation faster and more convenient. Most web sites (e.g. Yahoo, Amazon, CNN) have a vertical component and require the user to move down “branches” in order to find the required information—often requiring the user to load intermediate pages that are of no value. The present invention eliminates the need to load intermediary web pages and may enable direct connections between specific branches. For example, a Yahoo visitor who is presently looking at stock quotes may directly link to “Yahoo travel” without the need to reload the Yahoo Homepage. Additionally, by providing a consistent layout, the toolbar may provide a standardized tool for navigating Web sites and may reduce the learning process required to understand the architecture and layout of specific web sites. Furthermore, the use of site bookmarks 37 allows users to save the pages they like on the toolbar on a per-web-site basis. The advantage of this method is that the web-site bookmarks only appear when the user visits the web site and the browser is customized to the site. This creates an intuitive bookmark classification application whereby users can store the pages on the site that they like best and have these bookmarks automatically loaded when they re-visit the site.

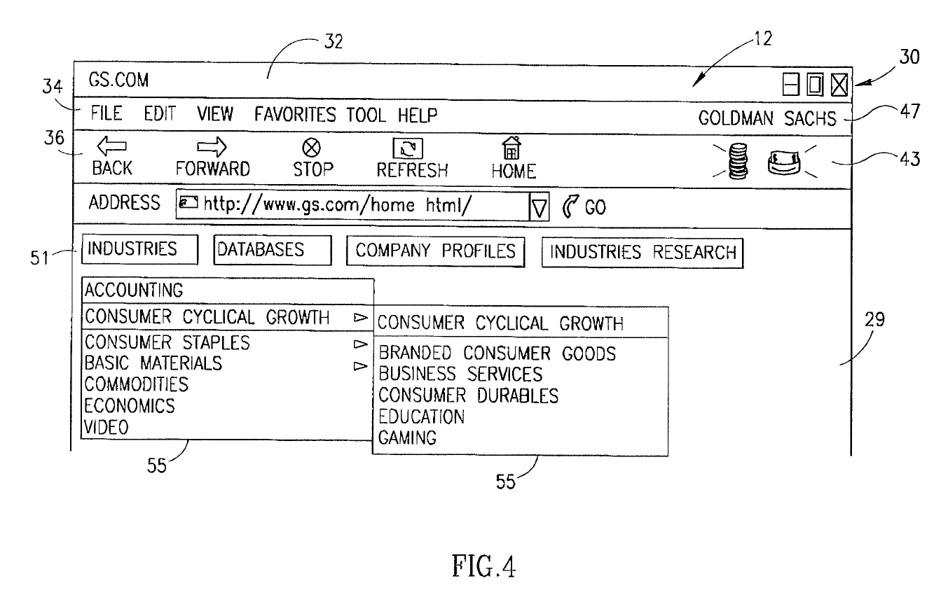

Another type of customization is category specific customization, which allows browser 12 to be customized on a category basis. With this method, web sites that provide similar services or related to the same field would be customized identically. An example of category specific customization is shown in FIG. 4, for the www.gs.com (GOLDMAN SACHS) web site. For example, in the category of financial web sites, such as, Merrill Lynch, Goldman Sachs and others, the web sites may be customized so as to provide information targeted at users who frequent such financial web sites (. Again, the browser modification may comprise dynamic graphics or a toolbar with pull-down windows 55. The browser top 30 may be “branded”, that is, modified with company logos 47 or product graphics 43, for example.

Another type of customization is user customization, which allows browser 12 to be customized based on the user's needs and preferences. An example of user customization is shown in FIG. 5. For example, a user may have the option to select a specific picture 57 to be displayed on browser 12 or a category of animations 59 that are rotated as the user surfs the net.

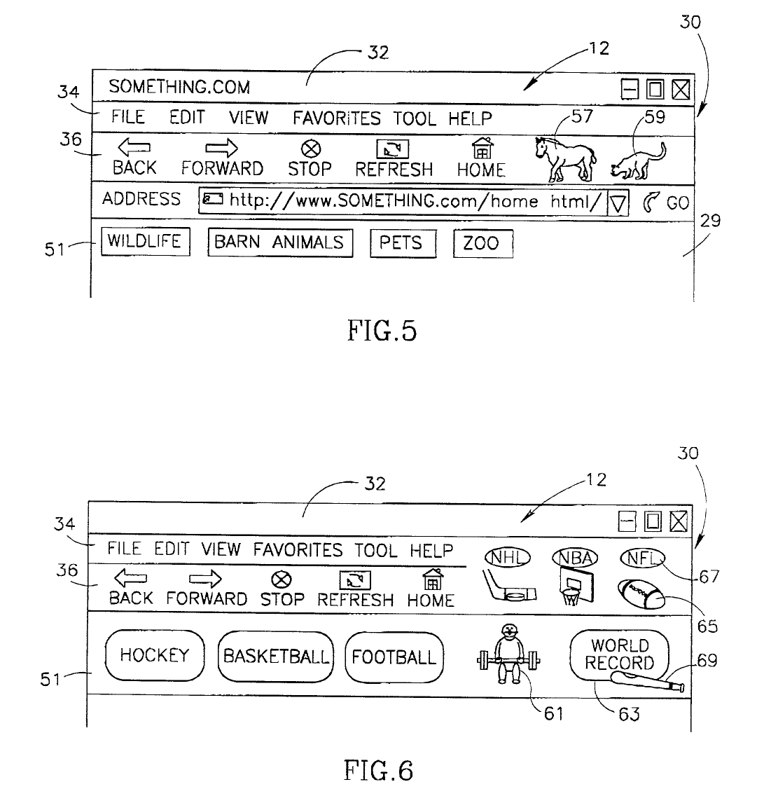

Another type of customization is theme-based customization, which uses a variety of preset morph information at the browser server to provide dynamic information to the browser. An example of theme-based customization is shown in FIG. 6. For example, a user can choose to receive a sport theme. While the user is surfing, the browser customization delivers changing sport related illustrations 61 and information 63. Furthermore, the browser environment may be customized according to this theme. For example, the browser buttons may have sport images 65, the navigation toolbar may have sport sites 67, and the mouse icon may change with sport related images 69.

Furthermore, a user who is a fan of the Chicago Bulls basketball team may have the option to choose a “Chicago Bulls” theme. After doing so, that user's browser environment may be customized with appropriate Bull's pictures, logos and related information, such as a basketball mouse icon, a basket-wise look of the normal rotating image, etc. (not shown).

As mentioned above, client module 14 may features, which are now described more in detail.

The client module 14 may be small and may be downloaded and installed within browser 12 or embedded within the browser 12 (as an OEM browser addition/extension, pre-install plug-in in or in any other way). The client module 14 may be connected to browser 12 in any suitable manner and continuously relay to browser server 16 the URL that is entered in the address bar or through a hyperlink. Browser server 16 may return morph data accordingly, and using this data, client module 14 may activate its “morph” modules and thus customize the look and functionality of browser 12.

In one download and registration process, the client module 14 may retrieve a UID from browser server 16 using registration server module 44. A UID may be assigned to client module 14 with default settings. Afterwards, the user may have the option to change the settings upon request, Changes may be registered and stored in the user database of browser server 16 to provide customized settings in the future.

The UID assignment process may take place on a per-PC basis. However, the user may have the option to use the same UID for different PCs. To maximize such portability, customized data (bookmarks, security setting, automatic complete information and the like) may be transferred from the client module 14 to the browser server 16, and may be sent back to the client module 14 upon the next login.

The client module 14 preferably includes a connection manager 21, which is adapted to establish and deal with communications between the client module 14 and the browser server 16, decode/encode, encrypt/decrypt and compress/decompress the property protocol and morph data according to encryption and compression protocols, and to synchronize morph data transfer with the browser activities so as to minimize waiting time.

The protocol defines the data structure, and includes the information necessary to customize browser 12 and the information and data needed to change each morph. An example of a protocol may be the following (although it is emphasized that this is just one example and the invention is not limited in any way to this example):

<?xml version=“1.0” encoding=“UTF-8”?>

<visualtop>

<profile vtpid=“200000926” type=“site” validate=“yes”>

interval time_length=“0”>

<top vtpid=“600002277”source=“hftp://Resources.VisualTop.com”/>

<toolbar source=“http://Resources.VisualTop.com” hot_source=“300000830”

cold_source=“300000831”>

<button index=“0”>amazon.com_{—}0

<menu vtpid=“800001713”source=“http://Resources.VisualTop.com”/>

</button>

<button index=“1”>amazon.com_{—}1

<menu vtpid=“800001714”source=“http://Resources.VisualTop.com”/>

</button>

<button index=“2”>amazon.com_{—}2

<menu vtpid=“800000609”source=“http://Resources.VisualTop.com”/>

</button>

<button index=“3”>Site Bookmarks<site_bookmarks/></button>

<button index=“4”action=“link”

action_cmd=“javascript:window.open(‘http://www.navixo.com/TellAFriend.asp’,‘Tel lAfriend’,‘height=565,width=320,left=200,top=100,scrollbar=0,toolbar=0,status=0,r esizable=0,menubar=0’);window.stop”>TellAfriend</button>

</toolbar>

</interval>

</profile>

</visualtop>

The connection manager 21 may be adapted to transfer morph data using a smart combination of a preload system and file caching in order not to interfere with the actual page download process. This may be done using prior knowledge of popular web sites that the user is visiting and of high traffic web site and portals. In this manner, the connection manager 21 may use inactivity times to download morph data to the user using a preload system, For example, morph data for other pages on the site may be downloaded as the user visits the home page of a web site.

The client module 14 preferably includes a pacer 23, which is adapted to control the time and activities intervals of morph data change. Such data change may be per time, per page change, per site change or any combination thereof.

The client module 14 preferably includes a cache module 18. The cache module 18 may store morph data locally, thereby reducing the need to download morph data from browser server 16, The cache module 18 may use a combination of push and pull cache mechanisms, as similarly described for the connection manager 21. For example, a user who revisits a web site may receive the morphs from the cache module 18 instead of from the browser server 16

The client module 14 preferably includes an automatic updating feature 24. The client module 14 may have a procedure to add new morph engines and to update its protocol in order to ask/receive new data according to the new morph. This may be done without updating the entire client module 14. This process may be automated. The browser server 16 may store a morph list per client, in order to track which data to send to the client and in order to send new morphs to all clients in the future.

It will be further appreciated that the present invention is not limited by what has been described hereinabove and that numerous modifications, all of which fall within the scope of the present invention, exist. Rather the scope of the invention is defined by the claims, which follow:

What is claimed is:

1. A method comprising:
identifying a Uniform Resource Locator (URL) associated with at least one content provider and a browser; and
customizing said browser by modifying at least one portion of said browser based upon said URL.

2. The method according to claim 1 wherein said modifying comprises updating said browser in accordance with at least one of a content provider criterion and a user preference criterion.

3. The method according to claim 2, wherein said at least one content provider belongs to a family of content providers that are categorized by at least one of a category and theme, and wherein said modifying comprises updating said browser in accordance with at least one of said category and said theme.

4. The method according to claim 1 and further comprising sending a request based upon said URL and a user identifier (UID) to a browser server, which is in communication with said browser.

5. The method according to claim 4 and further comprising providing said browser server with a database comprising at least one of user preference data and content provider data.

6. The method according to claim 5 wherein said modifying comprises creating browser modification information based upon said at least one of user preference data and content provider data, and sending said browser modification information to said browser.

7. The method according to claim 6 and further comprising:
receiving a web page from said content provider in accordance with said URL; and
displaying said web page by said browser and said modifying comprises updating said browser using said browser modification information.

8. The method according to claim 7 wherein said modifying comprises branding said browser with commercially related browser modification information.

9. Apparatus comprising:
a browser server adapted to modify a browser with browser modification information created by said browser server

10. Apparatus according to claim 9 wherein said browser modification information is adapted to change at least one of an appearance and functionality of said browser.

11. Apparatus according to claim 9 and further comprising a client module in communication with said browser server and said browser, said client module being adapted to change at least one of an appearance and functionality of said browser with said browser modification information.

12. Apparatus according to claim 9 wherein said browser modification information comprises at least one of a dynamic toolbar, a dynamic browser skin, and a dynamic browser user interface.

13. Apparatus according to claim 9 wherein said browser modification information comprises at least one of a dynamic navigation tool, a dynamic browser function button, a dynamic site bookmark, a dynamic rotating icon, a dynamic mouse icon, a dynamic hotkey, a dynamically shaped browser, and dynamic branded information.

14. Apparatus according to claim 9 wherein said browser server is adapted to process a request of a URL and a UID, and modify said browser in accordance with at least one of a content provider criterion and a user preference criterion, based upon said URL and said UID, respectively.
